(19) United States
(12) Patent Application Publication
(10) Pub. No.: US 2024/0281595 A1
(43) Pub. Date: Aug. 22, 2024

(54) Message Correction Method, Electronic Device, and Non-transitory Readable Storage Medium

(71) Applicant: VIVO MOBILE COMMUNICATION CO., LTD., Dongguan (CN)

(72) Inventor: Xiaogang Shen, Dongguan (CN)

(21) Appl. No.: 18/650,246

(22) Filed: Apr. 30, 2024

Related U.S. Application Data
(63) Continuation of application No. PCT/CN2022/128355, filed on Oct. 28, 2022.

(30) Foreign Application Priority Data
Nov. 1, 2021 (CN) 202111283696.X

(51) Int. Cl. G06F 40/166

(52) U.S. Cl. CPC G06F 40/166

(57) ABSTRACT

A message correction method includes obtaining a first keyword in a first message in a case of identifying that the first message includes a target identifier, where the target identifier is used to indicate that the first message is a correction message. The first message is a message input by a user in a current session page or the first message is a received message; and displaying the first message and a second message in an associated manner in a case that the second message includes a second keyword. The second message is a message before the first message in terms of time in the current session page, and the second keyword is a keyword matching the first keyword.

### CROSS-REFERENCE TO RELATED APPLICATIONS

This application is a Bypass Continuation Application of International Patent Application No. PCT/CN2022/128355, filed Oct. 28, 2022, and claims priority to Chinese Patent Application No. 202111283696.X, filed Nov. 1, 2021, the disclosures of which are hereby incorporated by reference in their entireties.

### BACKGROUND OF THE INVENTION

### Field of the Invention

This application pertains to the field of communication technologies, and in particular, relates to a message correction method, an electronic device, and a non-transitory readable storage medium.

### Description of Related Art

With development of electronic devices, functions of the electronic devices are increasingly diverse. For example, an electronic device may send a message through instant messaging software.

### SUMMARY OF THE INVENTION

According to a first aspect, an embodiment of this application provides a message correction method. The method includes: obtaining a first keyword in a first message in a case of identifying that the first message includes a target identifier, where the target identifier is used to indicate that the first message is a correction message, and the first message is a message input by a user in a current session page or the first message is a received message; and displaying the first message and a second message in an associated manner in a case that the second message includes a second keyword, where the second message is a message before the first message in terms of time in the current session page, and the second keyword is a keyword matching the first keyword.

According to a second aspect, an embodiment of this application provides a message correction apparatus. The apparatus includes an obtaining module and a display module, where the obtaining module is configured to: obtain a first keyword in a first message in a case of identifying that the first message includes a target identifier, where the target identifier is used to indicate that the first message is a correction message, and the first message is a message input by a user in a current session page or the first message is a received message; and the display module is configured to: display the first message and a second message in an associated manner in a case that the second message includes a second keyword, where the second message is a message before the first message in terms of time in the current session page, and the second keyword is a keyword matching the first keyword.

According to a third aspect, an embodiment of this application provides an electronic device, where the electronic device includes a processor, a memory, and a program or an instruction stored in the memory and executable on the processor, where when the program or the instruction is executed by the processor, steps of the method according to the first aspect are implemented.

According to a fourth aspect, an embodiment of this application provides a non-transitory readable storage medium, where the non-transitory readable storage medium stores a program or an instruction, and when the program or the instruction is executed by a processor, steps of the method according to the first aspect are implemented.

According to a fifth aspect, an embodiment of this application provides a chip, where the chip includes a processor and a communication interface, the communication interface is coupled to the processor, and the processor is configured to run a program or an instruction, to implement the method according to the first aspect.

### BRIEF DESCRIPTION OF THE DRAWINGS

The terms Fig., Figs., Figure, and Figures are used interchangeably in the specification to refer to the corresponding figures in the drawings.

FIG. 1 is a schematic diagram of a message correction method according to an embodiment of this application;

FIG. 2A is a first schematic diagram of an application interface of a message correction method according to an embodiment of this application;

FIG. 2B is a second schematic diagram of an application interface of a message correction method according to an embodiment of this application;

FIG. 2C is a third schematic diagram of an application interface of a message correction method according to an embodiment of this application;

FIG. 3A is a fourth schematic diagram of an application interface of a message correction method according to an embodiment of this application;

FIG. 3B is a fifth schematic diagram of an application interface of a message correction method according to an embodiment of this application;

FIG. 4 is a schematic diagram of a message correction apparatus according to an embodiment of this application;

FIG. 5 is a schematic diagram of an electronic device according to an embodiment of this application; and

FIG. 6 is a schematic diagram of hardware of an electronic device according to an embodiment of this application.

### DESCRIPTION OF THE INVENTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing an order or sequence. It should be understood that the data used in such a way is interchangeable in proper circumstances, so that the embodiments of this application can be implemented in an order other than the order illustrated or described herein. In addition, in this specification and the claims, “and/or” represents at least one of connected objects, and a character “/” generally represents an “or” relationship between associated objects.

It should be noted that the identifier in the embodiments of this application is used to indicate a character, a symbol, an image, or the like of information. A control or another container may be used as a carrier for displaying the information, including but not limited to a character identifier, a symbol identifier, or an image identifier.

Usually, if a user finds, on a session interface, that there is incorrect information in a message sent by the user or another user, the user needs to trigger the electronic device to re-edit the message in an input box, to obtain a corrected message, and trigger the electronic device to re-send the corrected message. However, there may be another message (for example, a message sent by the user or a message sent by another user) between the message in which there is incorrect information and the corrected message.

However, because there may be another message between the message in which there is incorrect information and the corrected message in the session interface, the corrected message may not implement a correction function. Therefore, correction effect of the foregoing message correction manner is poor.

The following describes, in detail, a message correction method and an apparatus, and an electronic device in the embodiments of this application through embodiments and application scenarios thereof with reference to the accompanying drawings.

The message correction method provided in the embodiments of the present application may be applied to a scenario of sending or receiving a correction message.

For example, using an example in which the electronic device sends a correction message, that is, the electronic device is used to send a first message and a second message, if a user finds that there is incorrect information in the second message in a current session page (for example, there is a typo in the second message), the user may input the first message in the current session page, and add a target identifier to the first message, to indicate that the first message is the correction message. In this case, the electronic device may obtain a first keyword in the first message, and identify, in the current session page, the second message including a second keyword matching the first keyword. After identifying the second message, the electronic device may display the first message and the second message in an associated display manner. In this way, because the electronic device does not display the first message in a default display manner of an application corresponding to the current session page, correction effect of the correction message of the electronic device can be improved.

For another example, using an example in which the electronic device receives the correction message, that is, the electronic device is used to receive the first message and the second message, if it is found that the first message is displayed in the current session page, and the first message includes a target identifier indicating that the message is the correction message, the electronic device may obtain the first keyword in the first message, and identify, in the current session page, the second message including a keyword matching the first keyword. After the second message is identified, the first message and the second message may be displayed in an associated display manner. It may be understood that, after receiving the first message, a receiver preferentially searches upward (earlier sending time) for whether there is the second message. In this way, because the electronic device does not display the first message in a default display manner of an application corresponding to the current session page, correction effect of the correction message of the electronic device can be improved.

Optionally, during actual implementation, the message correction method provided in the embodiments of the present application may be not only applied to a scenario of sending or receiving a correction message, but also applied to a scenario of supplementing descriptions for sent messages, or the like.

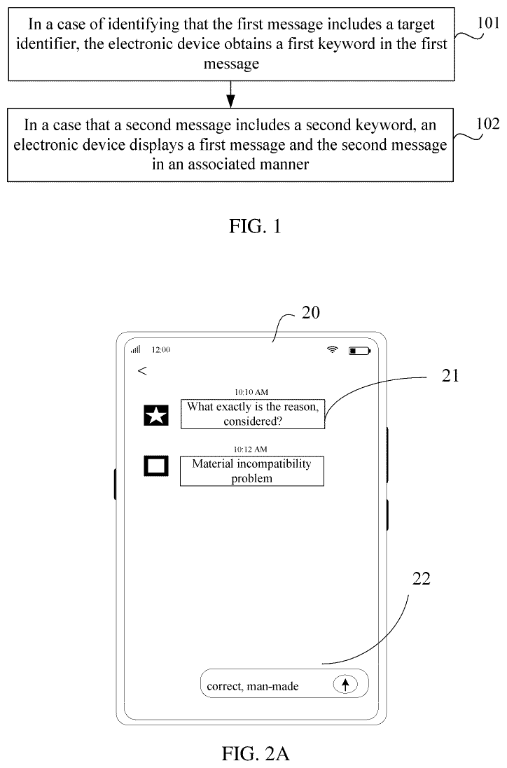

With reference to FIG. 1, an embodiment of this application provides a message correction method. The method may include the following step 101 and step 102. An example in which an electronic device performs the method is used below for description.

Step 101: The electronic device obtains a first keyword in a first message in a case of identifying that the first message includes a target identifier.

The target identifier may be used to indicate that the first message is a correction message, and the first message is a message input by a user in a current session page or the first message may be a message received by the electronic device, for example, a message received by the electronic device most recently.

It may be understood that, in this embodiment of this application, the target identifier may be set by a system by default, or may be user-defined. This may be determined according to an actual use requirement, provided that the target identifier can indicate that the first message is the correction message. This is not limited in this embodiment of this application.

In this embodiment of this application, the electronic device can obtain the first keyword in the first message only in the case of identifying that the first message includes the identifier indicating that the first message is the correction message, and does not need to identify keywords for all input or newly received messages. Therefore, overheads of the electronic device can be reduced.

Optionally, in this embodiment of this application, the target identifier may include at least one of the following: a correction keyword, a correction symbol, or a correction statement. This may be determined according to an actual use requirement, and is not limited in this embodiment of this application.

For example, the target identifier is a correction keyword “Correct”, a correction symbol “Δ”, a correction statement “Please correct”, or the like.

In this embodiment of this application, because the target identifier may include at least one of: the correction keyword, the correction symbol, or the correction statement, diversity of the target identifier can be improved.

Optionally, in this embodiment of this application, when the first message is the message input by the user in the current session page, the electronic device is a transmit end of the first message and the second message, the first message may be a text message that is input by the user in an input box and that is not sent; or the first message may be a text message that is input by the user in the input box and that is sent by the electronic device upon triggering by the user, the first message has been displayed in the current session page. This may be determined according to an actual use requirement, and is not limited in this embodiment of this application.

Optionally, in this embodiment of this application, when the first message is the message received by the electronic device, the electronic device is a receive end of the first message and the second message, the first message may be a message sent by a user of the other party in the current session page.

Optionally, in this embodiment of this application, there may be one or more (that is, at least two) first messages. This may be determined according to an actual use requirement, and is not limited in this embodiment of this application. When there are a plurality of first messages, the plurality of messages may be correction messages of one message, or may be correction messages of a plurality of messages. This may be determined according to an actual use requirement, and is not limited in this embodiment of this application.

Optionally, in this embodiment of this application, the electronic device may perform semantic analysis on the first message, to obtain the first keyword in the first message.

Optionally, in this embodiment of this application, there may be one or more (that is, at least two) first keywords. This may be determined according to the first message, and is not limited in this embodiment of this application.

Optionally, in this embodiment of this application, the first keyword may be text (Chinese character), or may be a letter. This may be determined according to an actual use requirement, and is not limited in this embodiment of this application.

Optionally, in this embodiment of this application, the foregoing session page may be a session page of the user and a contact, or may be a session page of the user and a group. This may be determined according to an actual use requirement, and is not limited in this embodiment of this application.

Step 102: The electronic device displays the first message and a second message in an associated manner in a case that the second message includes a second keyword.

The second message is a message before the first message in terms of time in the current session page, and the second keyword is a keyword matching the first keyword.

It may be understood that, the second message may be a message sent or received by the electronic device within preset duration before the first message is sent or received. The preset duration may be preset by the user, or may be set by the system by default. This may be determined according to an actual use requirement, and is not limited in this embodiment of this application.

For example, the second message is a message in all messages sent or received by the electronic device within one minute (that is, the preset duration) before the electronic device sends or receives the first message.

Optionally, in this embodiment of this application, that the second keyword is the keyword matching the first keyword may be understood as follows: A matching degree between a preset type of the second keyword and a preset type of the first keyword is greater than a first preset threshold. The first preset threshold may be preset by the user, or may be set by the system by default. This may be determined according to an actual use requirement, and is not limited in this embodiment of this application.

For example, the first preset threshold is 70%.

Optionally, in this embodiment of this application, the preset type may be: a stroke (for example, font style) type, a Pinyin type, a meaning type, or the like. This may be determined according to an actual use requirement, and is not limited in this embodiment of this application. In other words, the electronic device may match the second keyword with the first keyword through at least one of: a stroke, Pinyin, a meaning, or a letter.

Optionally, in this embodiment of this application, there may be one or more (that is, at least two) second messages. This may be determined according to an actual use requirement, and is not limited in this embodiment of this application.

Optionally, in this embodiment of this application, the second message may be a text message sent by the user, or may be a text message sent by another user in the current session page (that is, a received text message). This may be determined according to an actual use requirement, and is not limited in this embodiment of this application.

Optionally, in this embodiment of this application, for the description of the second keyword, reference may be made to the related description of the first keyword in the foregoing step 101. To avoid repetition, details are not described herein again.

Optionally, in this embodiment of this application, when the first message is the message input by the user in the current session page, the electronic device may display the first message and the second message in an associated manner after the first message is sent. After the electronic device displays the first message and the second message in an associated manner, a device of another user in the current session page may also display the first message and the second message in an associated manner in the corresponding session page. The associated manner in which the device of the another user displays the first message and the second message is the same as the associated manner in which the electronic device displays the first message and the second message. That is, the electronic device and the device of the another user display messages in a same display manner. In this way, all users participating in a session can learn that the first message is the correction message of the second message.

Optionally, in this embodiment of this application, when the first message is the message received by the electronic device, the electronic device may directly display the first message and the second message in an associated manner after determining that the second message includes the second keyword. It can be understood that, in this case, an electronic device of another user may display the first message and the second message in an associated manner, or may not display the first message and the second message in an associated manner. This may be determined according to an actual use requirement. In this way, the user of the electronic device can learn that the first message is the correction message of the second message.

Optionally, in this embodiment of this application, the foregoing step 102 may be implemented through the following step 102a or step 102b.

Step 102a: The electronic device displays the first message and the second message in a first display manner in a case that the second message includes the second keyword.

(i) The first display manner is as follows: A display manner of the first message and the second message is different from a display manner of another message in the current session page, that is, the first display manner is different from a default message display manner of an application corresponding to the current session page. Alternatively, (ii) the first display manner is as follows: A display manner of the second message is different from a display manner of another message in the current session page, and the first message is displayed in a preset area of the second message.

For example, in the foregoing (i), the first display manner may be highlighting, display in a manner different from a default font color of the application corresponding to the current session page, display in a manner of adding a special identifier to a message, or the like.

Optionally, in this embodiment of this application, during actual implementation, in the foregoing (i), the electronic device may display all or some of message content (the first keyword in the first message and the second keyword in the second message) of the first message and the second message in the first display manner. This may be determined according to an actual use requirement, and is not limited in this embodiment of this application.

Optionally, in this embodiment of this application, in the foregoing (ii), the preset area of the second message may be: an area adjacent to the second message and above the second message, an area adjacent to the second message and below the second message, an area adjacent to the second message and below the second message, an area adjacent to the second message and to the left of the second message, an area adjacent to the second message and to the right of the second message, or the like, and is any area that can enable the user to learn that the first message is the correction message of the second message. In this way, the electronic device can display the first message in the preset area of the second message, the correction message can be displayed in the vicinity of the corrected message. Therefore, it can be ensured that another user in the current session page or the user himself or herself quickly and accurately learns of the message in which there is incorrect information and the corrected content, so that correction effect of the correction message of the electronic device can be improved.

In this embodiment of this application, because the electronic device may display the second message and the correction message (that is, the first message) of the second message in different display manners, it is convenient for the user to associate the first message with the second message from a large quantity of session messages, so as to learn that the first message is the correction message of the second message.

Step 102b: The electronic device displays a third message in a case that the second message includes the second keyword.

The third message may be a message obtained by fusing the first message and the second message.

Optionally, in this embodiment of this application, the message obtained by fusing the first message and the second message may be understood as any one of the following (1) or (2):
(1) The electronic device generates a message according to message content of the first message and message content of the second message.

For example, the second message is “What exactly is the reason, considered?”, and the first message is “Correct, man-made”. In this case, the message generated by the electronic device according to the message content of the first message and the message content of the second message is “Correct: What exactly is the reason, man-made?”. The message obtained by fusing the first message and the second message is “Correct: What exactly is the reason, man-made?”.
(2) The electronic device replaces the second keyword in the second message with the first keyword in the first message.

For example, the second message is “What exactly is the reason, considered?”, the first message is “Correct, man-made”, and the electronic device identifies that the first message includes a “Correct” identifier. In this case, the electronic device obtains the first keyword “man-made” in the first message, and identifies and obtains that the second keyword “considered” in the second message matches the first keyword “man-made”, so that the electronic device can replace the second keyword in the second message with the first keyword. In this way, the third message “What exactly is the reason, man-made?” can be obtained by fusing the first message and the second message.

Optionally, in this embodiment of this application, the electronic device may display the third message in a default message display manner of the application corresponding to the current session page, may display the third message in the preset area of the second message, or may display the third message in a popup form. This may be determined according to an actual use requirement, and is not limited in this embodiment of this application.

Optionally, in this embodiment of this application, the electronic device may display a preset identifier in the third message. The preset identifier may be used to indicate that the message is a message generated by the electronic device according to the message content of the first message and the message content of the second message.

Optionally, in this embodiment of this application, the preset identifier includes at least one of the following: a correction keyword, a correction symbol, or a correction statement.

For example, the preset identifier is a keyword identifier “Correct:”, a symbol identifier “Δ”, a statement identifier “Please correct”, or the like.

Optionally, in this embodiment of this application, when the first message is a message that is input by the user in the input box and that is not sent (that is, the first message is a message input by the user in the current session page), before displaying the third message, the electronic device may alternatively directly display the third message in the input box under triggering by the user. Because the third message is a message obtained by fusing the first message and the second message, the user previews message content of the third message in the input box, and after finding that the message content of the third message meets a requirement, the user may click a send button, to trigger the electronic device to send and display the third message, so as to send and display the complete and correct statement directly on the current session page.

In this embodiment of this application, the electronic device may display the first message and the second message in a display manner different from a display manner of another message in the current session page; or display the message obtained by fusing the first message and the second message. Therefore, compared with a solution that a correction message is displayed in a default display manner of an application corresponding to a current session page, the solution provided in this embodiment of this application can improve correction effect of the correction message of the electronic device.

Optionally, in this embodiment of this application, due to a limited display area of a screen, the first message and the second message may not be on a same interface of the session page at the same time. In this case, the user may trigger, through a sliding input in the session page, the electronic device to display the message that is not displayed in the session page.

Optionally, in this embodiment of this application, after determining that the second message includes the second keyword, the electronic device may first determine whether the first message and the second message can be on the same interface, and if the first message and the second message are on the same interface, the electronic device may display the first message and the second message in the first display manner; or if the first message and the second message are not on the same interface, the electronic device may display the third message obtained by fusing the first message and the second message. In this way, regardless of whether the first message and the second message are on the same interface, the user can accurately learn that the first message is the correction message of the second message.

Optionally, in this embodiment of this application, the electronic device may determine, in the following two manners (respectively: a manner 1 and a manner 2), whether the first message and the second message are on a same interface.

### Manner 1

Optionally, in this embodiment of this application, the electronic device may determine, based on a quantity of messages between the first message and the second message, whether the first message and the second message are on the same interface. In a case that the quantity is greater than or equal to a preset quantity, the electronic device may determine that the first message and the second message are on the same interface. In a case that the quantity is less than the preset quantity, the electronic device may determine that the first message and the second message are not on the same interface. The preset quantity may be set by the system by default or may be user-defined. This may be determined according to an actual use requirement, and is not limited in this embodiment of this application.

For example, the preset quantity is 5. In a case that the quantity of messages between the first message and the second message is 4, the electronic device may determine that the first message and the second message are on the same interface; and in a case that the quantity of messages between the first message and the second message is 8, the electronic device may determine that the first message and the second message are not on the same interface.

### Manner 2

Optionally, in this embodiment of this application, the electronic device may determine, in a screen identification manner, whether the first message and the second message are on the same interface.

For example, after the electronic device sends the first message (that is, the first message is a message input by the user), the electronic device performs screen identification on the current session page, and may perform a screen capture operation on the current session page, so as to identify a screenshot image. In a case that the electronic device identifies that the screenshot image includes both the first message and the second message, the electronic device may determine that the first message and the second message are on the same interface; and in a case that the electronic device identifies that the screenshot image does not include both the first message and the second message, the electronic device may determine that the first message and the second message are not on the same interface.

Optionally, in this embodiment of this application, the electronic device may delete the screenshot image after determining whether the first message and the second message are on the same interface.

It may be understood that, any implementation that can determine whether the first message and the second message are on the same interface falls within the protection scope of this application.

Optionally, in this embodiment of this application, the foregoing step 102a may be implemented through the following step 102a1, and the foregoing step 102b may be implemented through the following step 102b1.

Step 102a1: In a case that the second message includes the second keyword, the electronic device displays the first message and the second message in the first display manner in a case that the first message and the second message are on a same interface.

For details of other descriptions in step 102a1, reference may be made to the related descriptions in the foregoing embodiment. To avoid repetition, details are not described herein again.

Optionally, in this embodiment of this application, that the first message and the second message are on the same interface may be understood as follows: The first message and the second message may be displayed simultaneously through the screen of the electronic device. In other words, when the electronic device displays the current session page, the electronic device may determine that the first message and the second message are on the same interface if both the first message and the second message are visible to the user.

Optionally, in this embodiment of this application, in a case that the first message and the second message are on the same interface, the electronic device may alternatively display the first message in the preset area of the second message. For details of the description of the preset area, reference may be made to the related description of the preset area of the second message in the foregoing embodiment. To avoid repetition, details are not described herein again.

Step 102b1: In a case that the second message includes the second keyword, the electronic device displays the third message in a case that the first message and the second message are not on a same interface.

For details of other descriptions in step 102b1, reference may be made to the related descriptions in the foregoing embodiment. To avoid repetition, details are not described herein again.

The following describes step 102a1 and step 102b1 by using examples with reference to the accompanying drawings.

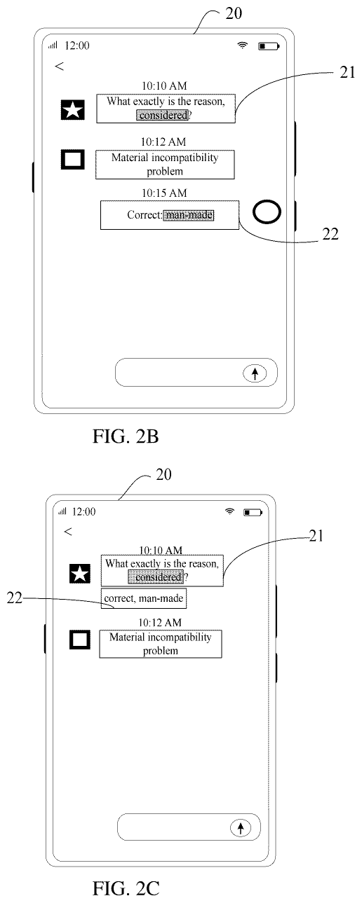

For example, as shown in FIG. 2A, when the user finds that there is incorrect information “consider” in the second message 21 “What exactly is the reason, considered?” in the current session page 20, the user may input the first message 22 “Correct: man-made” in the input box of the current session page 20. The electronic device identifies that the first message includes the target identifier “Correct”, and obtains the first keyword “man-made” in the first message, and then the electronic device may identify, based on a stroke or Pinyin matching degree, that the second message 21 includes the second keyword “consider” matching the first keyword, so that after the user triggers the electronic device to send the first message, that is, clicks a send control (the arrow in FIGS. 2A, 2B, or 2C) in the current session page 20, in a case that the first message 22 and the second message 21 are on the same interface, as shown in FIG. 2B, the electronic device displays “man-made” in the first message 22 “Correct: man-made” and “consider” in the second message 21 “What exactly is the reason, considered?” in a highlighting manner (that is, the first display manner); or, as shown in FIG. 2C, the electronic device displays “consider” in the second message 21 in the highlighting manner, and displays the first message 22 in an area below the second message 21. In a case that the second message includes the second keyword, the electronic device displays the first message and the second message in the first display manner in a case that the first message and the second message are on the same interface.

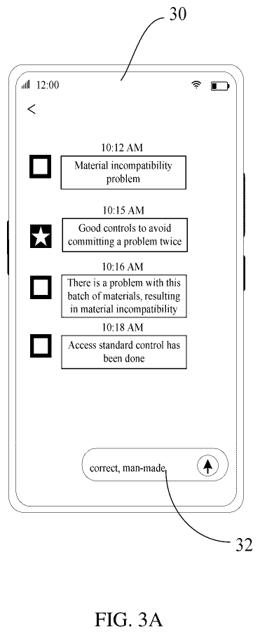

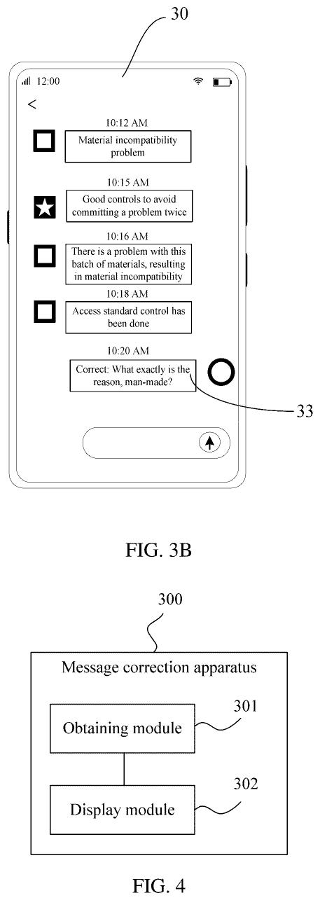

For example, as shown in FIG. 3A, when the user finds that there is incorrect information “consider” in the second message “What exactly is the reason, considered?” (not shown in the figure) in the current session page 30, the user may input the first message 32 “Correct, man-made” in the input box of the current session page 30. The electronic device identifies that the first message includes the target identifier “Correct”, and obtains the first keyword “man-made” in the first message, and then the electronic device may identify, based on a stroke or Pinyin matching degree, that the second message 31 includes the second keyword “consider” matching the first keyword. Then, the electronic device may perform a screen capture operation on the current session page. Because the screenshot image does not include the second message, the electronic device may determine that the first message and the second message are not on the same interface. Therefore, as shown in FIG. 3B, the electronic device may display the third message 33 “Correct: What exactly is the reason, man-made?”. In a case that the second message includes the second keyword, the electronic device displays the third message in a case that the first message and the second message are not on the same interface.

In this embodiment of this application, because the electronic device may determine a message display manner based on whether the first message and the second message are on the same interface, flexibility and accuracy of displaying the correction message by the electronic device can be improved, and user experience can be improved.

In the message correction method provided in this embodiment of this application, the electronic device may obtain the first keyword in the first message in a case of identifying that the first message input or received in the current session page includes the target identifier, and display the first message and the second message in an associated manner in a case that the second message before the first message in terms of time in the current session page includes the keyword matching the first keyword, instead of displaying the first message and the second message in the default display manner of the application corresponding to the current session page. Therefore, correction effect of the correction message of the electronic device can be improved.

The following describes the manner of determining the second keyword by the electronic device by using examples in which a preset type matching degree is a stroke type matching degree and/or a Pinyin type matching degree.

Optionally, in this embodiment of this application, before the foregoing step 102, the message correction method provided in this embodiment of this application may further include the following step 103 and step 104.

Step 103: The electronic device obtains a first character string of the first keyword and a second character string of the second message.

Optionally, in this embodiment of this application, the first character string may be strokes and/or Pinyin, and the like of the first keyword. This may be determined according to an actual use requirement, and is not limited in this embodiment of this application.

Optionally, in this embodiment of this application, the second character string may be strokes and/or Pinyin, and the like of the second message. This may be determined according to an actual use requirement, and is not limited in this embodiment of this application.

Optionally, in this embodiment of this application, when the first character string is strokes, the second character string is also strokes; and when the first character string is Pinyin, the second character string is also Pinyin. In other words, types of the first character string and the second character string are the same.

Step 104: In a case that the second character string includes a first sub character string matching the first character string, the electronic device determines a keyword corresponding to the first sub character string as the second keyword.

Optionally, in this embodiment of this application, that the second character string includes the first sub character string matching the first character string may be understood as follows: A matching degree between the first character string and the first sub character string is greater than a first preset threshold.

For example, if the first preset threshold is 70%, and the matching degree between the first character string and the first sub character string is 80%, it indicates that the first character string matches the first sub character string.

In this embodiment of this application, the electronic device may match the first character string of the obtained first keyword with the second character string of the second message, and determine, from the second message, the first sub character string matching the first character string, so that accuracy of determining the second keyword in the second message by the electronic device can be improved.

It should be noted that, the message correction method provided in this embodiment of this application may be performed by a message correction apparatus or a control module that is in the message correction apparatus and that is configured to perform the message correction method. In this embodiment of this application, the message correction apparatus provided in the embodiments of this application is described by using an example in which the message correction method is performed by the message correction apparatus.

With reference to FIG. 4, an embodiment of this application provides a message correction apparatus. The message correction apparatus may include an obtaining module 301 and a display module 302. The obtaining module 301 may be configured to: obtain a first keyword in a first message in a case of identifying that the first message includes a target identifier, where the target identifier is used to indicate that the first message is a correction message, and the first message is a message input by a user in a current session page or the first message is a received message; and the display module 302 may be configured to: display the first message and a second message in an associated manner in a case that the second message includes a second keyword, where the second message is a message before the first message in terms of time in the current session page, and the second keyword is a keyword matching the first keyword.

Optionally, in this embodiment of this application, the target identifier includes at least one of the following: a correction keyword, a correction symbol, or a correction statement.

Optionally, in this embodiment of this application, the display module 302 may be configured to display the first message and the second message in a first display manner, where the first display manner is different from a display manner of another message in the current session page; or display a third message, where the third message is a message obtained by fusing the first message and the second message.

Optionally, in this embodiment of this application, the display module 302 may be configured to: in a case that the first message and the second message are on a same interface, display the first message and the second message in the first display manner; or, in a case that the first message and the second message are not on a same interface, display the third message.

Optionally, in this embodiment of this application, the apparatus further includes: a determining module; the obtaining module 301 is further configured to obtain a first character string of the first keyword and a second character string of the second message before the first message and the second message are displayed in an associated manner; and the determining module is configured to: in a case that the second character string includes a first sub character string matching the first character string, determine a keyword corresponding to the first sub character string as the second keyword.

In the message correction apparatus provided in this embodiment of this application, the apparatus may obtain the first keyword in the first message in a case of identifying that the first message input or received in the current session page includes the target identifier, and display the first message and the second message in an associated manner in a case that the second message before the first message in terms of time in the current session page includes the keyword matching the first keyword, instead of displaying the first message and the second message in the default display manner of the application corresponding to the current session page. Therefore, correction effect of the correction message of the apparatus can be improved.

For beneficial effect of the implementations in this embodiment, refer to the beneficial effect of the corresponding implementations in the foregoing method embodiment. To avoid repetition, details are not described herein again.

The message correction apparatus in this embodiment of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a notebook computer, a palmtop computer, an in-vehicle electronic device, a wearable device, an ultra-mobile personal computer (UMPC), a netbook, or a personal digital assistant (PDA). The non-mobile electronic device may be a server, a network attached storage (NAS), a personal computer (PC), a television (TV), a teller machine, a self-service machine, or the like. This is not limited in this embodiment of this application.

The message correction apparatus in this embodiment of this application may be an apparatus with an operating system. The operating system may be an Android operating system, an iOS operating system, or another possible operating system. This is not limited in this embodiment of this application.

The message correction apparatus provided in this embodiment of this application can implement each process for implementing the method embodiment of FIG. 1. To avoid repetition, details are not described herein again.

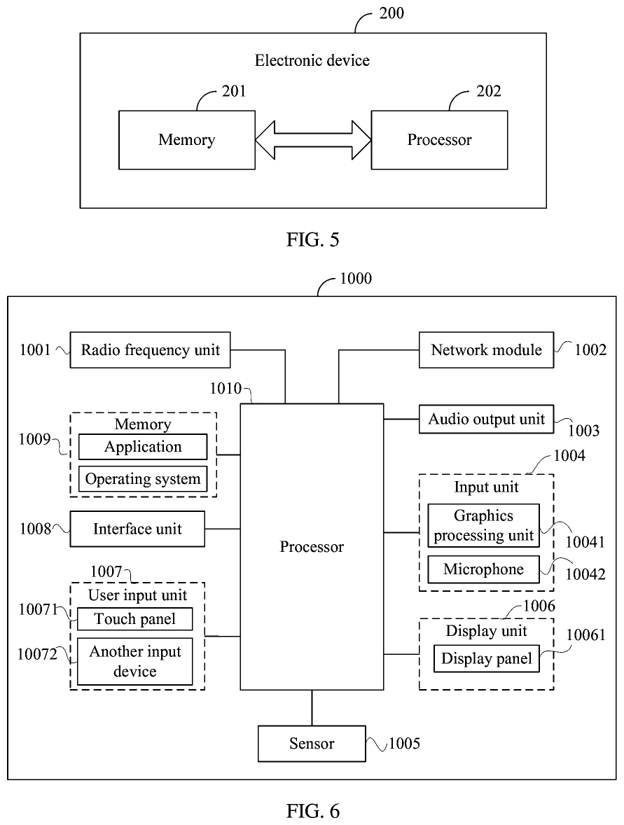

As shown in FIG. 5, an embodiment of this application further provides an electronic device 200, including a processor 202, a memory 201, and a program or an instruction stored in the memory 201 and executable on the processor 202. When the program or the instruction is executed by the processor 202, each process of the foregoing method embodiment of the message correction method is implemented, and same technical effect can be achieved. To avoid repetition, details are not described herein again.

It should be noted that the electronic device in this embodiment of this application includes the foregoing mobile electronic device and the foregoing non-mobile electronic device.

FIG. 6 is a schematic diagram of a hardware structure of an electronic device according to an embodiment of this application.

The electronic device 1000 includes but is not limited to: a radio frequency unit 1001, a network module 1002, an audio output unit 1003, an input unit 1004, a sensor 1005, a display unit 1006, a user input unit 1007, an interface unit 1008, a memory 1009, a processor 1010, and other components.

A person skilled in the art can understand that the electronic device 1000 may further include a power supply (such as a battery) that supplies power to each component. The power supply may be logically connected to the processor 1010 by using a power supply management system, to implement functions such as charging and discharging management, and power consumption management by using the power supply management system. The structure of the electronic device shown in FIG. 6 does not constitute a limitation on the electronic device. The electronic device may include more or fewer components than those shown in the figure, or combine some components, or have different component arrangements. Details are not described herein again.

The processor 1010 may be configured to: obtain a first keyword in a first message in a case of identifying that the first message includes a target identifier, where the target identifier is used to indicate that the first message is a correction message, and the first message is a message input by a user in a current session page or the first message is a received message; and the display unit 1006 may be configured to: display the first message and a second message in an associated manner in a case that the second message includes a second keyword, where the second message is a message before the first message in terms of time in the current session page, and the second keyword is a keyword matching the first keyword.

Optionally, in this embodiment of this application, the target identifier includes at least one of the following: a correction keyword, a correction symbol, or a correction statement.

Optionally, in this embodiment of this application, the display unit 1006 may be configured to display the first message and the second message in a first display manner, where the first display manner is different from a display manner of another message in the current session page; or display a third message, where the third message is a message obtained by fusing the first message and the second message.

Optionally, in this embodiment of this application, the display unit 1006 may be configured to: in a case that the first message and the second message are on a same interface, display the first message and the second message in the first display manner; or, in a case that the first message and the second message are not on a same interface, display the third message.

Optionally, in this embodiment of this application, the processor 1010 is further configured to obtain a first character string of the first keyword and a second character string of the second message before the first message and the second message are displayed in an associated manner; and the processor 1010 is further configured to: in a case that the second character string includes a first sub character string matching the first character string, determine a keyword corresponding to the first sub character string as the second keyword.

In the electronic device provided in this embodiment of this application, the electronic device may obtain the first keyword in the first message in a case of identifying that the first message input or received in the current session page includes the target identifier, and display the first message and the second message in an associated manner in a case that the second message before the first message in terms of time in the current session page includes the keyword matching the first keyword, instead of displaying the first message and the second message in the default display manner of the application corresponding to the current session page. Therefore, correction effect of the correction message of the electronic device can be improved.

For beneficial effect of the implementations in this embodiment, refer to the beneficial effect of the corresponding implementations in the foregoing method embodiment. To avoid repetition, details are not described herein again.

It should be understood that, in this embodiment of this application, the input unit 1004 may include a graphics processing unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. The display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein. The memory 1009 may be configured to store a software program and various data, including but not limited to an application and an operating system. The processor 1010 may be integrated with an application processor and a modem processor. The application processor mainly processes an operating system, a user interface, an application, and the like. The modem processor mainly processes wireless communication. It may be understood that, alternatively, the modem processor may not be integrated into the processor 1010.

An embodiment of this application further provides a non-transitory readable storage medium, where the non-transitory readable storage medium stores a program or instruction, and when the program or the instruction is executed by a processor, each process of the foregoing embodiment of the message correction method is implemented, and same technical effect can be achieved. To avoid repetition, details are not described herein again.

The processor is the processor in the electronic device in the foregoing embodiment. The foregoing non-transitory readable storage medium includes a non-transitory computer-readable storage medium, such as a computer read-only memory (ROM), a random access memory (RAM), a magnetic disk, a compact disc, or the like. An embodiment of this application further provides a chip, where the chip includes a processor and a communication interface, the communication interface is coupled to the processor, and the processor is configured to run a program or an instruction, to implement each process of the foregoing embodiment of the message correction method, and same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. Without further limitation, an element defined by the statement “includes a . . . ” does not exclude the existence of another same element in the process, method, article or apparatus in which the element is included. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be reflected in a form of a computer software product. The computer software product is stored in a storage medium (such as a ROM/RAM, a magnetic disk, or a compact disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A message correction method, wherein the method comprises:
obtaining a first keyword in a first message in a case of identifying that the first message comprises a target identifier, wherein the target identifier is used to indicate that the first message is a correction message, and the first message is a message input by a user in a current session page or the first message is a received message; and
displaying the first message and a second message in an associated manner in a case that the second message comprises a second keyword, wherein the second message is a message before the first message in terms of time in the current session page, and the second keyword matches the first keyword.

2. The method according to claim 1, wherein the target identifier comprises at least one of following: a correction keyword, a correction symbol, or a correction statement.

3. The method according to claim 1, wherein the displaying the first message and the second message in an associated manner comprises:
displaying the first message and the second message in a first display manner, wherein the first display manner is different from a display manner of another message in the current session page; or
displaying a third message, wherein the third message is a message obtained by fusing the first message and the second message.

4. The method according to claim 3, wherein the displaying the first message and the second message in an associated manner comprises:
in a case that the first message and the second message are on a same interface, displaying the first message and the second message in the first display manner; or,
in a case that the first message and the second message are not on a same interface, displaying the third message.

5. The method according to claim 1, wherein before the displaying the first message and the second message in an associated manner, the method further comprises:
obtaining a first character string of the first keyword and a second character string of the second message; and
in a case that the second character string comprises a first sub character string matching the first character string, determining a keyword corresponding to the first sub character string as the second keyword.

6. An electronic device, comprising a processor, a memory, and a program or an instruction stored in the memory and executable on the processor, wherein the program or the instruction, when executed by the processor, causes the electronic device to perform:
obtaining a first keyword in a first message in a case of identifying that the first message comprises a target identifier, wherein the target identifier is used to indicate that the first message is a correction message, and the first message is a message input by a user in a current session page or the first message is a received message; and
displaying the first message and a second message in an associated manner in a case that the second message comprises a second keyword, wherein the second message is a message before the first message in terms of time in the current session page, and the second keyword matches the first keyword.

7. The electronic device according to claim 6, wherein the target identifier comprises at least one of following: a correction keyword, a correction symbol, or a correction statement.

8. The electronic device according to claim 6, wherein the program or the instruction, when executed by the processor, causes the electronic device to perform:
displaying the first message and the second message in a first display manner, wherein the first display manner is different from a display manner of another message in the current session page; or
displaying a third message, wherein the third message is a message obtained by fusing the first message and the second message.

9. The electronic device according to claim 8, wherein the program or the instruction, when executed by the processor, causes the electronic device to perform:
in a case that the first message and the second message are on a same interface, displaying the first message and the second message in the first display manner; or,
in a case that the first message and the second message are not on a same interface, displaying the third message.

10. The electronic device according to claim 6, wherein the program or the instruction, when executed by the processor, causes the electronic device to further perform:
obtaining a first character string of the first keyword and a second character string of the second message; and
in a case that the second character string comprises a first sub character string matching the first character string, determining a keyword corresponding to the first sub character string as the second keyword.

11. A non-transitory readable storage medium, wherein the non-transitory readable storage medium stores a program or an instruction, and the program or the instruction, when executed by a processor of an electronic device, causes the electronic device to perform:
obtaining a first keyword in a first message in a case of identifying that the first message comprises a target identifier, wherein the target identifier is used to indicate that the first message is a correction message, and the first message is a message input by a user in a current session page or the first message is a received message; and
displaying the first message and a second message in an associated manner in a case that the second message comprises a second keyword, wherein the second message is a message before the first message in terms of time in the current session page, and the second keyword matches the first keyword.

12. The non-transitory readable storage medium according to claim 11, wherein the target identifier comprises at least one of following: a correction keyword, a correction symbol, or a correction statement.

13. The non-transitory readable storage medium according to claim 11, wherein the program or the instruction, when executed by the processor, causes the electronic device to perform:
displaying the first message and the second message in a first display manner, wherein the first display manner is different from a display manner of another message in the current session page; or
displaying a third message, wherein the third message is a message obtained by fusing the first message and the second message.

14. The non-transitory readable storage medium according to claim 13, wherein the program or the instruction, when executed by the processor, causes the electronic device to perform:
in a case that the first message and the second message are on a same interface, displaying the first message and the second message in the first display manner; or,
in a case that the first message and the second message are not on a same interface, displaying the third message.

15. The non-transitory readable storage medium according to claim 11, wherein the program or the instruction, when executed by the processor, causes the electronic device to further perform:
obtaining a first character string of the first keyword and a second character string of the second message; and
in a case that the second character string comprises a first sub character string matching the first character string, determining a keyword corresponding to the first sub character string as the second keyword.

16. A chip, wherein the chip comprises a processor and a communication interface, the communication interface is coupled to the processor, and the processor is configured to run a program or an instruction, to implement the message correction method according to claim 1.

17. A chip, wherein the chip comprises a processor and a communication interface, the communication interface is coupled to the processor, and the processor is configured to run a program or an instruction, to implement the message correction method according to claim 2.

18. A chip, wherein the chip comprises a processor and a communication interface, the communication interface is coupled to the processor, and the processor is configured to run a program or an instruction, to implement the message correction method according to claim 3.

19. A chip, wherein the chip comprises a processor and a communication interface, the communication interface is coupled to the processor, and the processor is configured to run a program or an instruction, to implement the message correction method according to claim 4.

20. A chip, wherein the chip comprises a processor and a communication interface, the communication interface is coupled to the processor, and the processor is configured to run a program or an instruction, to implement the message correction method according to claim 5.
